(19) United States
(12) Patent Application Publication
(10) Pub. No.: US 2024/0217597 A1
(43) Pub. Date: Jul. 4, 2024

(54) Autonomous Electric Tractor

(71) Applicant: ZTRACTOR, Palo Alto, CA (US)

(72) Inventors: Bakur Kvezereli, Palo Alto, CA (US); Stefan Marjanovic, Central Serbia (RS)

(73) Assignee: ZTRACTOR, Palo Alto, CA (US)

(21) Appl. No.: 18/092,237

(22) Filed: Dec. 31, 2022

(51) Int. Cl. B62D 49/06; B60L 50/60

(52) U.S. Cl. CPC B62D 49/0635; B60L 50/60; B60L 2200/40; B60L 2260/48

(57) ABSTRACT

The autonomous electric tractor is completely operated by battery and remote programming using artificial intelligence and soil sensors. The electric track has an in-track electric motor to drive a rear drivetrain sprocket to provide movement to the autonomous electric tractor. The electric tracks are slip proof and tilt proof. The mudguards protect them heavy soil contamination. The autonomous electric tractor is controlled by a cloud based remote tractor management system. Apart from 3D cameras and sensors, global positioning system and client need based data is used for utilizing the tractor for farming operations.

### FIELD OF THE INVENTION

The present invention relates to an autonomous electrical tractor and a system for controlling the same.

### BACKGROUND OF THE INVENTION

According to the most recent estimate by the UN, the world population is estimated to reach 9.7 billion by 2050. This means the world's current food production will have to grow by 70% to support and feed a growing population by the year by 2050. Farmers also need to be equipped with tools to help them glean insights into how to improve their yields and make informed decision.

We are now faced with many challenges of how we can meet the world's food needs, respecting the environment, taking into account that population is set to reach 9.7 billion by 2050 and arable land decreases by 100,000 hectares per year, global agricultural production needs to double in the next 30 years to cope with demand. We cannot address these challenges without investment in new technologies along with government policy changes and long-term implications of these technologies.

Farming is a tedious and necessary job. Farmers make very little money and spend 18% of their total expense in labor. Due to environmental factors there are many challenges to get the right labor force and cover their health benefits. Farming can be a dangerous industry to work in due to inherent risks of working with large equipment and other environmental factors. This technology is headed towards enhancing the level of safety in farming. The conventional farm equipment's consume a lot of fuel and that adds to the cost of food production. The maintenance budget of the old equipment's also cuts into farmer's profit. There is a need for automation in farming to address these needs.

### SUMMARY

The instant application discloses an autonomous electrical tractor and system. The autonomous electrical tractor comprises of a main body, electric track and universal adaptive undercarriage. In one embodiment, the main body carries the battery, a computer with a software management system and sits on top of the universal adaptive undercarriage.

In one embodiment, a universal adaptive undercarriage comprises of a first horizontal support member, a second horizontal support member, a connecting arm to attach a electric track and a rotating base to receive a main body of the autonomous electrical tractor is disclosed. The connecting arm, in one embodiment is embedded with electrical connections and actuators to move the connecting arm. The autonomous electric tractor system enables remote control of the connecting arm based on the protocol and terrain of the farm. The front and back side of the universal undercarriage has the ground engaging mechanism to attach farm equipment's.

In another embodiment, an electric track has a left electric track and a right electric track of a specific design is connected to the universal adaptive undercarriage for making the autonomous electrical tractor move. In one embodiment, the main body carries a battery, a communication system and a controller for a remote tractor management system of the autonomous electrical tractor is fixed to the universal adaptive undercarriage; and the remote tractor management system that controls the autonomous electrical tractor during a farming session by receiving input from the user.

An object of the present invention is to relieve the farmer from expense anxiety and enable them to use autonomous electrical tractor which is electric and autonomous in nature. The global positioning system helps control the autonomous electrical tractor to be controlled with either preloaded protocols or customized protocols for a specific farm land and/or farmers need. In one embodiment, soil sensor data is fed back to the system so that real time adjustment can be made for the use of autonomous electrical tractor.

In one embodiment, an autonomous electrical tractor module and system is implemented using a processor, device, battery, global positioning system and hardware to perform at optimal capacity and use the autonomous electrical tractor. In another embodiment, a closed loop control system is implemented to deliver the prescribed farming protocols for the user for the use of the autonomous electrical tractor. Multiple soil sensors are used to detect the soil conditions and the input protocol for a specific farming protocol, and based on the feedback received; a proprietary control algorithm sends the corrective actuation signals to the motors of autonomous electrical tractor. A sensor based input from the autonomous electrical tractor is collected in the database and used by artificial intelligence module for calculations for evaluation and recommendation of the optimal steps, function and routes for the autonomous electrical tractor.

In one embodiment, a cloud based software system or internet based system is used for data gathering, analysis and control of the autonomous electrical tractor. In one embodiment, the soil sensor is attached to the undercarriage at the back. In another embodiment, the soil sensor is placed on the main body and connected to the cloud based tractor management system using global positioning system and database. In one embodiment, mud guards are situated in the inner portion of the wheel base. In one embodiment the autonomous electrical tractor is used for all activities of farming, such as sowing, weeding, harvesting, planting, planning, fertilizing, watering and collecting produce etc.

Other features will be apparent from the accompanying drawings and from the detailed description that follows.

### BRIEF DESCRIPTION OF THE DRAWINGS

The other objects, features and advantages will occur to those skilled in the art from the following description of the preferred embodiment and the accompanying drawings in which:

FIG. 1 illustrates a schematic perspective front view of an autonomous electrical tractor, according to an embodiment of the present invention.

FIG. 2 illustrates a back view of the autonomous electrical tractor.

FIG. 3 illustrates a soil sensor attached to the autonomous electrical tractor in the front.

FIG. 4 shows the expanded view of the autonomous electrical tractor.

FIG. 5 shows the inner view of the main body of the autonomous electrical tractor.

FIG. 6 shows the battery assembly in the autonomous electrical tractor.

FIG. 7 shows how the undercarriage and electric track are assembled together.

FIG. 8 shows the expanded view of the undercarriage and the electric tracks.

FIG. 9 shows the main body for the autonomous electrical tractor, in one embodiment.

FIG. 10 shows a side view of electric track, in one embodiment.

FIG. 11 shows the electric track with its rubber tracks.

FIG. 12 shows a side view of the electric track without the guard.

FIG. 13 shows a side view of the electric track with the connectors.

FIG. 14 shows the shows a side view of the electric track with the motor.

FIG. 15 shows electric track with the position of the sprockets and wheel.

FIG. 16 shows the top view of the electric track with the rubber rails.

FIG. 17 shows the automatic electric tractor system and its control.

FIG. 18 shows electric track with a single sprocket design, in one embodiment.

Other features of the present embodiments will be apparent from the accompanying drawings and from the detailed description that follows.

### DETAILED DESCRIPTION

Several components, systems and methods for using an autonomous electric tractor are disclosed. The instant tractor is eco-friendly as compared to traditional tractors. The instant tractor is more efficient than conventional tractors. The diesel tractor has 35% efficiency when it converts thermal energy into mechanical energy. Electric tractors have fewer moving parts, meaning fewer things that go wrong. So repairing and maintenance costs reduce and these tractor works for longer periods. The instant disclosure shows that there are fewer parts in the said invention and battery operated autonomous electric tractor can be remotely operated by farmers, with more time efficiency as attachments can be interchanged without much effort.

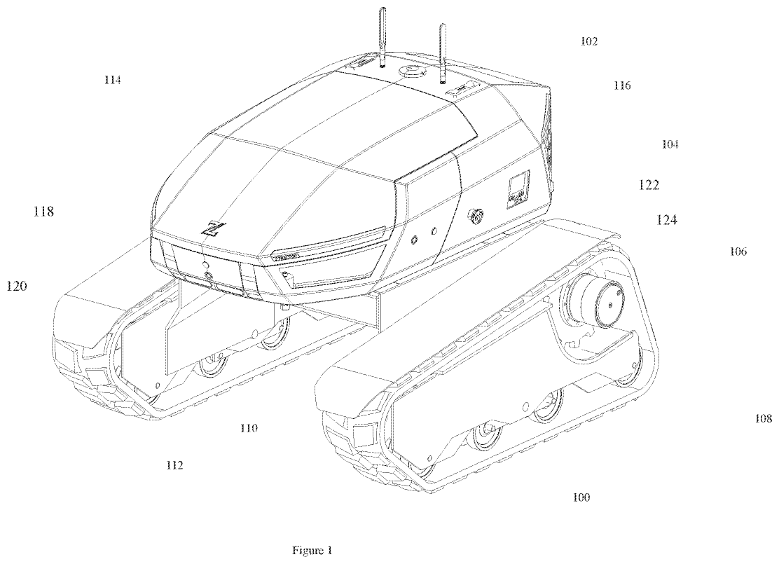

FIG. 1 shows the entire autonomous electric tractor 100. The main body 104 contains a WiFi antenna 102, a global positioning system connectivity device 116 and which is mounted on a universally adaptable undercarriage 110. The undercarriage 110 is flanked by a set of electric track comprising of a first electric track and a second electric track 108. Each electric track is protected by mudguard 106. The electric track is also shielded vertically by a track holder 112. The control panel 122 to manually operate the autonomous electric tractor is situated on the main body. An emergency stop button 124 is also placed on the main body. The main body is made of light material, such as plastic, but not limited to it. There are several 3D cameras 120 and 118 located at the lower front and sides of the main body. The pictures taken from these are conveyed to cloud based remote tractor management system software for including as data for remote tractor system to do function calculations. Several soil sensors 114, heat sensors, humidity sensors and distance sensors are located around the main body of the tractor so they can gather data in real time to be conveyed to remote tractor management system.

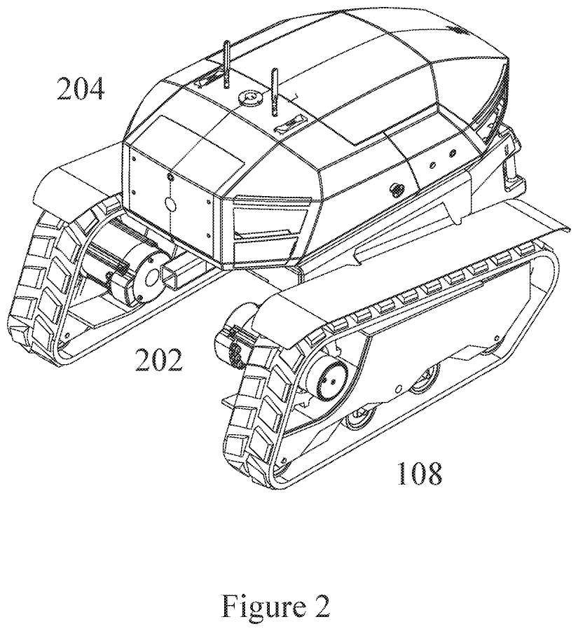

FIG. 2 illustrates a back view of the autonomous electrical tractor. The electric track 108 is shown to have a unique shape. The farm implements or any other attachments to the autonomous electric tractor can be done by attaching the implement using the back hitch 202. The main body has an opening 204. The farm implements may be plows, harrows, fertilizer spreads, seeders, balers, wagons and trailers, sprayers, mowers, cultivators, rakes, and soil sensors.

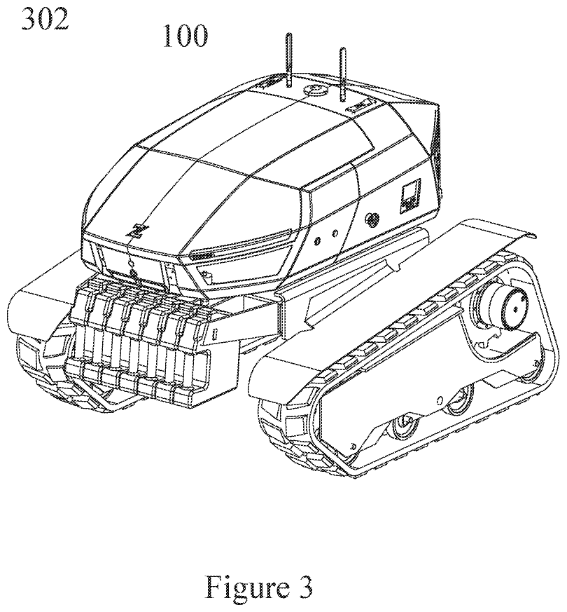

FIG. 3 illustrates a soil sensor 302 attached to the autonomous electrical tractor 101 in the front. Soil sensors 114 are used for various purposes. An autonomous sensor system capable of capturing a variety of soil physical parameters is built so that simultaneously soil properties could be derived. Together the autonomous electric tractor and soil sensor allows for autonomous measurement of soil characteristics using point-based measurements. The system included a newly developed cone penetrometer and combined air permeameter and CO2 sensor, as well as an off-the-shelf sensor for soil moisture, temperature, and apparent electrical conductivity. The soil parameters along with other sensor parameters allow farm activities such as planting design, sowing the crop, harvesting, fertilizing, and other farm activity that can be autonomously. The soil sensor can be attached in the front of the tractor or hitched on the back of the tractor. The soil sensor accesses the soil conditions, maps planting maps, recommends soil alterations based on artificial intelligence data and local conditions.

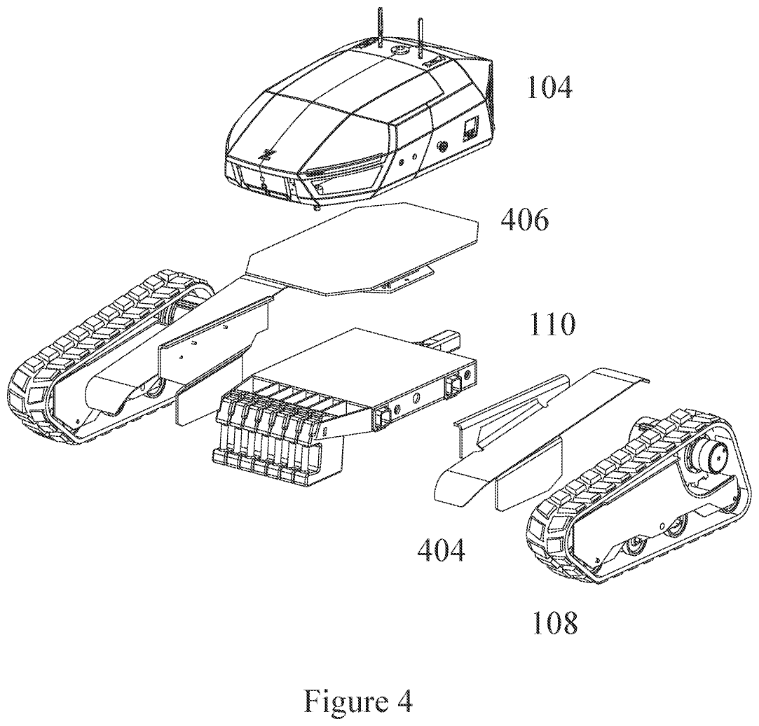

FIG. 4 shows the expanded view of the autonomous electrical tractor. The main body 104 sits on a metal plate 406 that is attached to the universal undercarriage 110. The track system 108 is attached to the universal undercarriage by the mudguards 404. The mudguards protect the track system from the side and from the top.

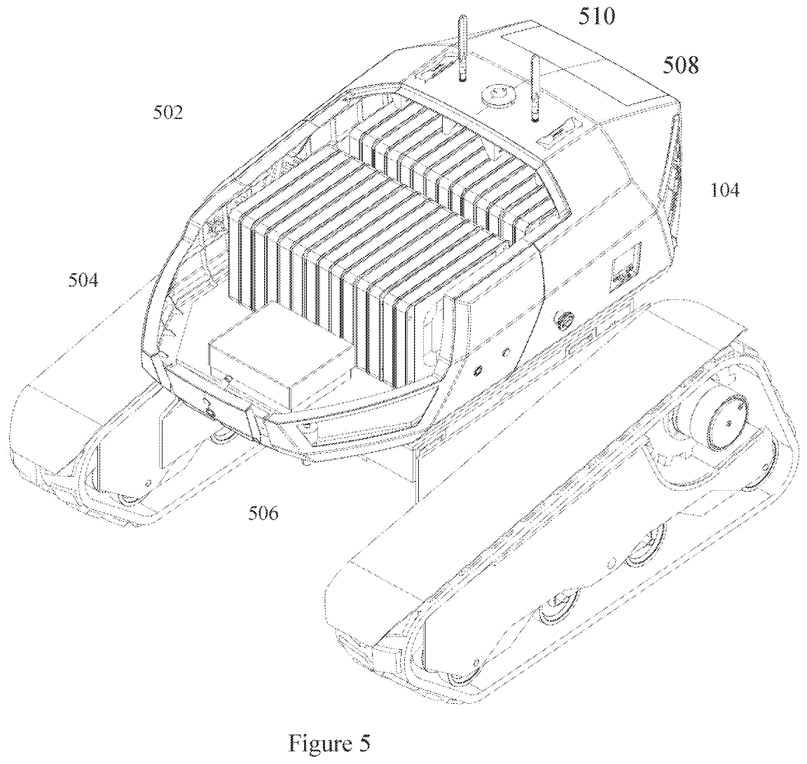

FIG. 5 shows the inner view of the main body of the autonomous electrical tractor. The battery stacks 502 are located in the main body 104 of the tractor. They are positioned in such a way that they provide the weight and balance to the whole autonomous electric tractor. They provide the crucial power to the motors, communication systems and the computer 504 to operate the tractor. The floor 506 of the main body is insulated and carries all the electrical systems to connect various parts of the autonomous electric tractor.

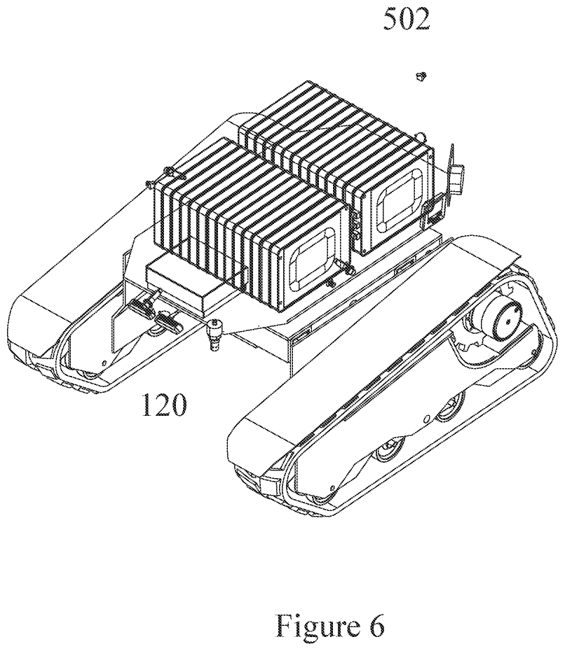

FIG. 6 shows the battery assembly in the autonomous electrical tractor. The batteries 502 shown here have their own computer for managing the battery system. The battery system manages the power consumption, distribution and conservation algorithms for optimal use of the equipment.

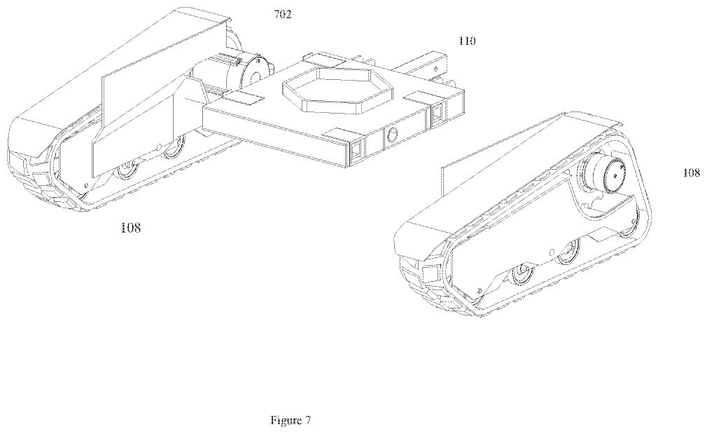

FIG. 7 shows how the universal undercarriage 110 and electric track are assembled together. The universal undercarriage shown here with collapsed first horizontal support member, second horizontal support member, connecting arm to attach to the electric track 108 through the vertical mudguard 702. The back side of the universal undercarriage has the ground engaging mechanism 704 to attach farm equipment's.

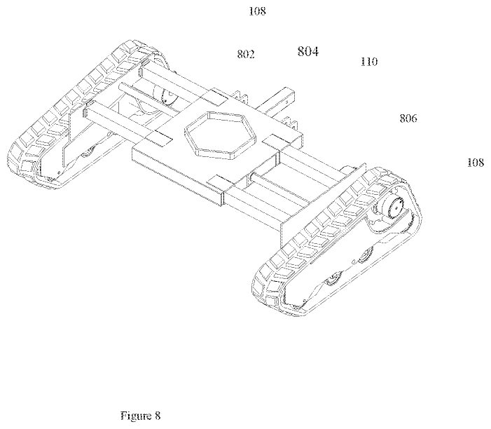

FIG. 8 shows the expanded view of the undercarriage and the electric tracks. The universal undercarriage shown here with expanded first horizontal support member 802, second horizontal support member 806, connecting arm to attach to the electric track 108 and a rotating base 804 to receive a main body of the autonomous electrical tractor.

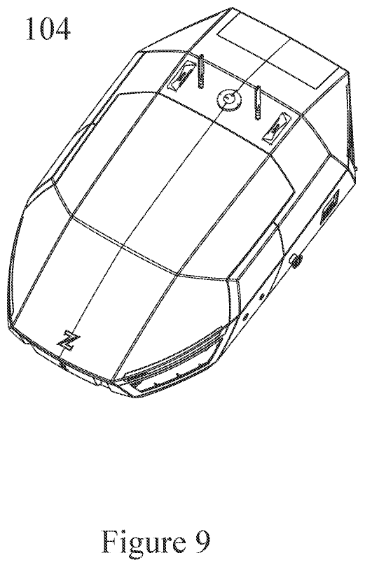

FIG. 9 shows the main body for the autonomous electrical tractor, in one embodiment. The main body 104 is contoured to withstand wind resistance and accommodate several battery packs. It is made up of light weight material such as plastic etc. The main body houses computers, controller, communication devices; control switches, and enables communication with cloud based tractor management system. The main body carrying a battery, a communication system and a controller for a remote tractor management system of the autonomous electrical tractor is fixed to the universal adaptive undercarriage.

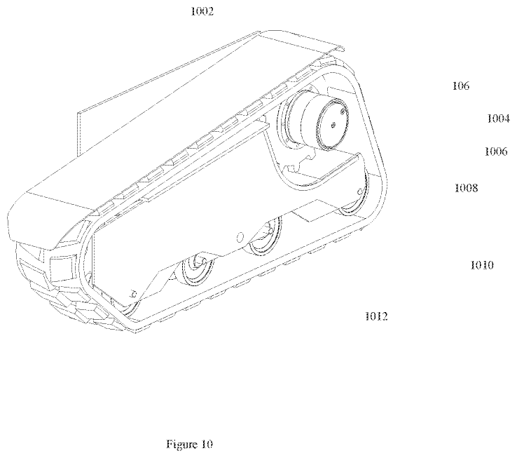

FIG. 10 shows a side view of electric track, having an in-track motor 1004 powered by battery and controlled by track management system. The in-track motor to drive a rear drivetrain sprocket to provide movement to the autonomous electric tractor. The electric track comprise of a rubber belt, front sprocket, rear sprocket 1008 for drivetrain, multiple idler wheels 1010, main metal holder 1002, electric motor 1004, electric gearbox and metal connector 702 to universal adaptive undercarriage and mudguard 106. There are four metal idler wheels 1010 spread along the length of the electric track. The center idler wheels are flexible and allow terrain specific flexibility to the electric track mobility. The corner idler wheels are rigid and support structural integrity to the electric track. The electric track has a rubber serrated strip 1012 that allows the autonomous electric tractor to move effortlessly. The rubber belt sits on a chained track. Chained tracks are built from modular chain links which together compose a closed chain. The track chain is joined by the hinges which allow tracks to be flexible and to distribute weight equally to set off the wheels. The idler wheel is not fully fixed on the steel construction, but it can have axial movement, supported by spring in order to increase tension on the chained track. The purpose of the increased tension on the track is to minimize track oscillation during the movement.

The mudguard, connecting strip 1102 is made out of metal and holds the interior moving parts securely. Electric tracks are the electromechanical mechanism used for engaging machines (tractors) with ground for driving operations with an autonomous or manual mode using an onboard computer (GPU) or remote control devices. Steel construction (including mudguard) of the electric track provides a rigid structure that combines all parts into one working assembly. An electric in-track geared motor is attached directly into steel construction with the fixed motor housing and with the Sprocket drive with the motor shaft. Sprocket drive is connected by the motor shaft and engaging with holes in the track links or with pegs on them to drive the track. This pushing or pulling of the track chain forced the chain to rotate around the wheels, which provide moving of the vehicle. Track rollers/road wheels 1208 and 1206 are rollers that provide the most of the vehicle weight thru a chained track into the ground. These can be mounted with additional suspension system or mounted in pairs called bogies. Carrier roller 1210 supporting the track on the upper side to reduce oscillating of the chained track when is not in contact with the ground (upper part of the track).

The electrical continuous track is a system for vehicle propulsion used in the tracked vehicles. The large surface area in contact with the ground allows distribution of the weight with smaller pressure on the ground in comparison with the wheeled vehicle. This property allows to tracked vehicle to goes to softer ground, as well as to have a smaller impact on ground compression in comparison with the wheeled vehicle with the same weight. Requirements to have lighter, less noise, and less damage on the paved roads is contributed to use Rubber chained track instead of the steel chained track.

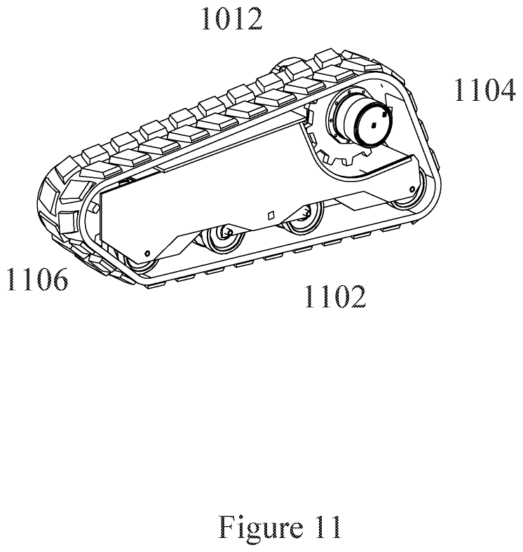

FIG. 11 shows the electric track with its rubber tracks 1012. The electric track has a specific angle in the front height 1106 and in the rear height 1104. The rear height of the electric track is bigger than the front height. The rubber strip has serrations 1012 so that there is no slip during the movement of the autonomous electric tractor.

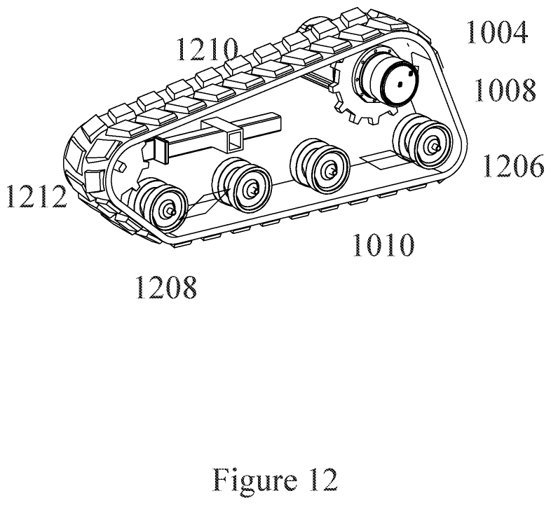

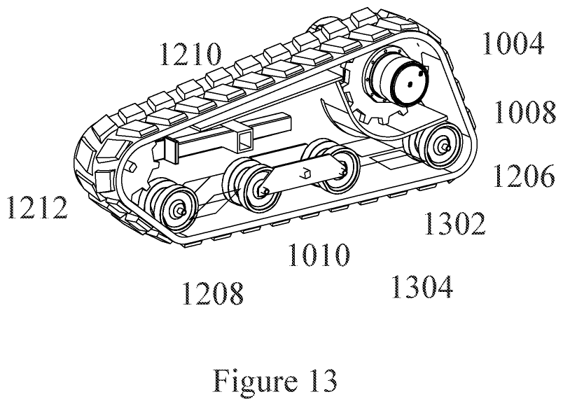

FIG. 12 shows a side view of the electric track without the guard. The front sprocket 1212 and carrier roller 1210 are visible in this view. FIG. 13 shows a side view of the electric track with the connectors. A steel cover and case 1302 separates the electric motor 1004 and idler wheels 1010. The idler wheels are help in position by another steel plate 1304.

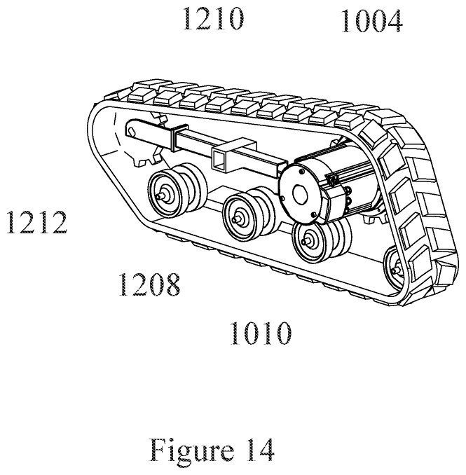

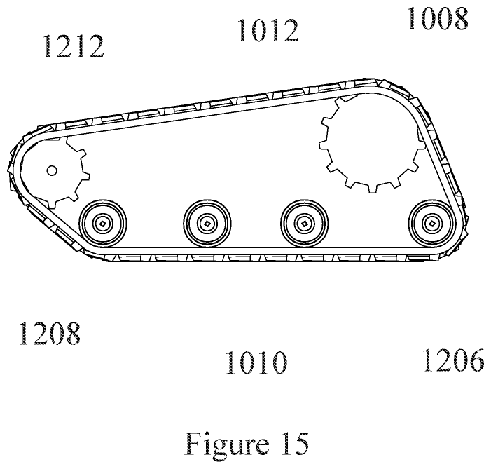

FIG. 14 shows the shows a side view of the electric track with the motor. The back to front view shows the orientation of yet another unique design of the said electric tractors electric track design. The compact and self-sufficient design allows the electric track from getting too soiled due to steel mudguard and provides a solid shape for the tracks to function well. FIG. 15 shows electric track with the position of the sprockets and wheel. The bare bones view shows the idler wheels, sprockets, rubber wheel and the shape of the electric track. The shape is specific in that it is narrower in the front and broader in the back.

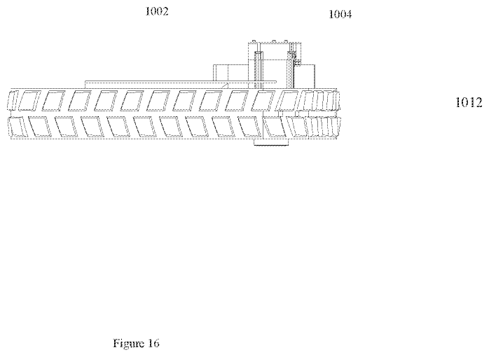

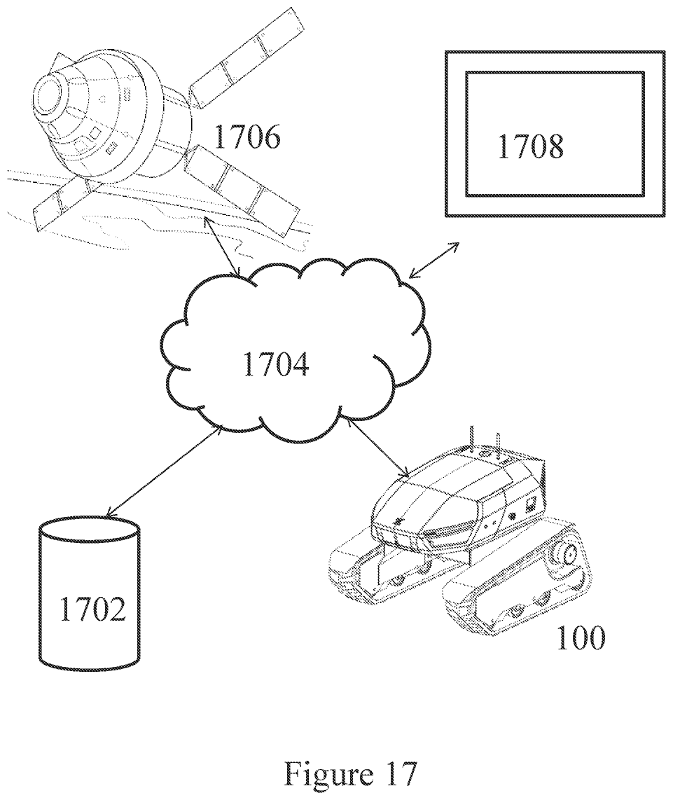

FIG. 16 shows the top view of the electric track with the rubber rails. The serrated rubber tracks are clearly visible in this embodiment. The motor 1004 and the mudguard 1002 are clearly shown. FIG. 17 shows the automatic electric tractor system and its control. The cloud based internet connection 1704 remote tractor control system is shown in this figure. The autonomous electric tractor 100 is controlled by remote device 1708 using cloud based software using an internet connection 1704. The data generated is stored and used for calculation in a database 1702. The data is gathered by the sensors, camera and computer onboard the tractor and passed on to the database and a device 1708 using a satellite or any remote system 1706. The remote tractor management system is used to control the autonomous electrical tractor during a farming session by receiving input from the user 1708. The artificial intelligence engine residing on a processor of the computer enables the user to control and navigation of the electric tractor. The entire mechanism is powered by the batteries.

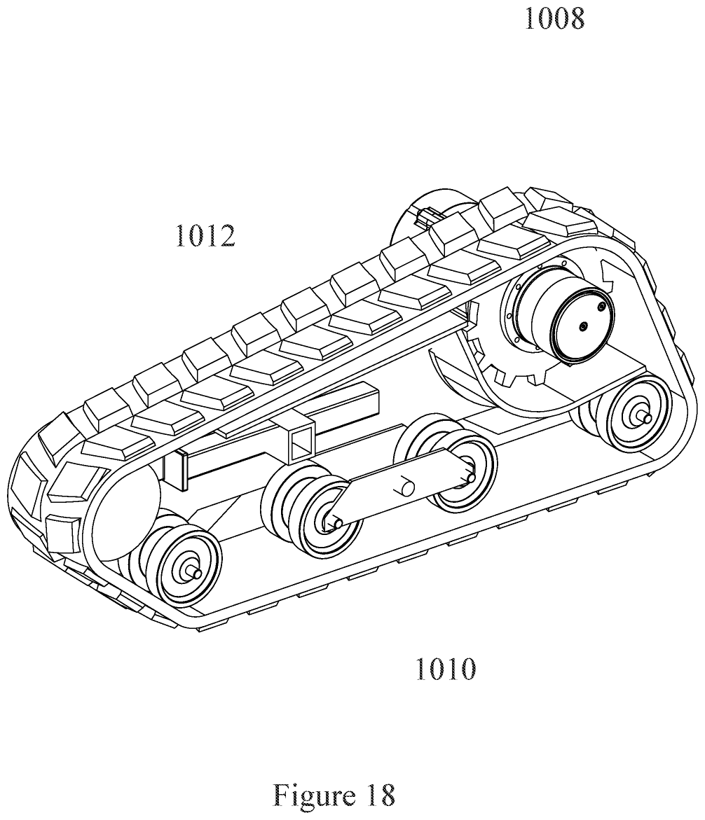

FIG. 18 shows another embodiment of the electric track having only one sprocket. The autonomous electric tractor may have various combination of sprockets to improve efficiency and smooth operation of the tractor. It may also be changed to suit the terrain and weight of the implement that is attached.

In one example, a method of using the autonomous electric tractor may be described as follows: a land that needs to be farmed may use the autonomous electric tractor for the very first instance with a soil sensor attachment and survey the soil for planting design, soil condition, even what type of crop is ideal for the said farm. Once the electric tractor has done its entire survey using soil sensors, camera and other sensors the tractor management system runs the artificial intelligence software to recommend, ideal distance for planting certain crops, mapping the entire farm land for optimal placement of plants or crop, soil management for the said crop, if necessary recommend additions or remedies to make it suitable for the said crop. The user may hitch the right instrument to prepare the soil, add or remove certain components from the soil, attach another implement to till, seed or spray necessary agricultural seeds or plants. If live plants are being sowed the undercarriage and the arms of the undercarriage are adjusted using on board computer or remote controlled using the tractor management system. The example cited is no means limiting the autonomous tractor for this specific use only, but it was cited as one of the embodiments of the said autonomous electric tractor.

Although the embodiments herein are described with various specific embodiments, it will be obvious for a person skilled in the art to practice the invention with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. An autonomous electrical tractor, comprising:
a universal adaptive undercarriage having a first horizontal support member, a second horizontal support member, a connecting arm to attach an electric track, a ground engaging mechanism to connect a farm implement and a rotating base to receive a main body of the autonomous electrical tractor;
the electric track having a left electric track and a right electric track of a specific design connected to the universal adaptive undercarriage for making the autonomous electrical tractor move;
the main body carrying a battery, a communication system and a controller for a remote tractor management system of the autonomous electrical tractor is fixed to the universal adaptive undercarriage; and
the remote tractor management system that controls the autonomous electrical tractor during a farming session by receiving input from the user.

2. The autonomous electrical tractor of claim 1, wherein the electric track comprise of a rubber belt, front sprocket, rear sprocket, multiple metal idler wheels, main metal holder, electric motor, electric gearbox and metal connector to universal adaptive undercarriage and mudguard.

3. The autonomous electrical tractor of claim 1, wherein the specific design of the electric track comprises of a wider end which houses the rear sprocket, electric motor, one metal wheel and a narrower end which houses the front sprocket, gear wheel and one metal wheel.

4. The autonomous electrical tractor of claim 3, wherein the specific design enables the autonomous electric tractor to move smoothly and without losing balance.

5. The autonomous electrical tractor of claim 1, wherein an electric motor specifically attached to the electric track to have an independent in track electric drivetrain.

6. The autonomous electrical tractor of claim 1, further comprising;
a wifi antenna, global positioning system, multiple sensors and 3D cameras that give input to the remote tractor management system, wherein the sensors are at least one of a temperature sensor, distance sensor, humidity sensor and soil sensor.

7. The autonomous electrical tractor of claim 1, wherein the connecting arm of the universal adaptive undercarriage is moved by an actuator powered by electric motor and can collapse and expand between 0.6 meters minimum to 1.5 meters.

8. An autonomous electrical tractor, comprising:
an electric track having an in-track electric motor to drive a rear sprocket to provide movement to the autonomous electric tractor;
a main body carrying a battery, a communication system and a computer to receive instructions from a cloud based remote tractor management system and attached to a universal adaptive undercarriage; and
a remote tractor management system that controls the movement of the autonomous electrical tractor during a farming session by receiving input from the user.

9. The autonomous electrical tractor of claim 8, wherein the electric track comprises of a rubber belt, front sprocket, rear sprocket, multiple metal idler wheels, main metal holder, electric motor, electric gearbox and metal connector that connects the electric track to the universal adaptive undercarriage and mudguard.

10. The autonomous electrical tractor of claim 8, wherein the remote tractor management system receives a data from the sensors are at least one of a temperature sensor, distance sensor, humidity sensor, camera and soil sensor.

11. An autonomous electrical tractor, comprising:
a main body carrying a battery, a communication system and a computer to receive instructions from a cloud based remote tractor management system and attached to a universal adaptive undercarriage; and
an electric track having an in-track electric motor to drive a rear sprocket to provide movement to the autonomous electric tractor, wherein the electric track is built from a modular chain links which together compose a closed chain, wherein the electric track comprises of a rubber belt which is mounted on the modular chain links, front sprocket, rear sprocket, multiple metal idler wheels, main metal holder, electric motor, electric gearbox and metal connector that connects the electric track to the universal adaptive undercarriage and mudguard.

12. The autonomous electrical tractor of claim 11, wherein a specific design of the electric track comprises of a wider end which houses the rear sprocket, electric motor, one metal wheel and a narrower end which houses the front sprocket, gear wheel and one metal wheel.

13. The autonomous electrical tractor of claim 11, further comprising of;
a camera to capture image data, a sensor to capture chemical and physical data in real time, soil sensor to capture soil condition data for a remote tractor management system that controls the movement of the autonomous electrical tractor during a farming session by receiving input from the user.

14. The autonomous electrical tractor of claim 11, further comprising of;
a universal adaptive undercarriage having a connecting arm to attach to a ground engaging mechanism such a farm implement.
